(19) United States
(12) Patent Application Publication
(10) Pub. No.: US 2009/0199392 A1
(43) Pub. Date: Aug. 13, 2009

(54) ULTRASOUND TRANSDUCER PROBES AND SYSTEM AND METHOD OF MANUFACTURE

(75) Inventors: Prabhjot Singh, Guilderland, NY (US); Martin Kin-Fei Lee, Niskayuna, NY (US); James Anthony Brewer, Scotia, NY (US); Paul Aloysius Meyer, McVeytown, PA (US); Thomas James Batzinger, Burnt Hills, NY (US); Venkat Subramaniam Venkataramani, Clifton Park, NY (US); James Norman Barshinger, Scotia, NY (US); Ernest Wayne Balch, Ballston Spa, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 12/060,402

(22) Filed: Apr. 1, 2008

Related U.S. Application Data
(60) Provisional application No. 61/027,659, filed on Feb. 11, 2008.

(51) Int. Cl. H04R 31/00

(52) U.S. Cl. 29/594

(57) ABSTRACT

A method for fabricating an ultrasound transducer structure is disclosed. The method includes performing the steps of forming a functional layer, including an ultrasound transducer material and a photopolymer, and exposing a plurality of selected regions of the functional layer to a programmable light pattern to cure the selected regions of the functional layer to form polymerized ultrasound transducer material regions, repeatedly. The method further includes selectively removing unexposed regions of the functional layer to obtain a green component, and sintering the green component to obtain the sensing structure. A system for making at least one piezoelectric element is also disclosed.

### CROSS REFERENCE TO RELATED APPLICATIONS

This application claims the benefit of U.S. Provisional Application No. 61/027659 filed on Feb. 11, 2008, which is incorporated herein in its entirety by reference.

### BACKGROUND OF THE INVENTION

The invention relates generally to the manufacture of a single element probe with a wide range of geometries and an array of piezoelectric elements. In particular, the invention relates to a method for manufacturing a piezoelectric probe including an array of piezoelectric elements. The invention also relates to a system for manufacturing an array of piezoelectric elements.

Piezoelectric probes including an array of piezoelectric elements are known for use in several applications, in particular for nondestructive imaging of the interior of structures by, for instance, ultrasound scanning. In many such imaging applications, it is desirable to reduce the size of the individual piezoelectric elements as much as possible, as that may allow operation at higher frequencies, which in turn may provide increased resolution in the obtained image. Conventionally used dice-and-fill methods for manufacturing piezoelectric probes reach a resolution limit when the columnar elements in the piezoelectric probe are less than about 30 microns in cross-section. As mentioned previously, operation of the probe at higher frequencies may be achieved by decreasing the thickness of the ultrasound probes and/or by decreasing the cross-section of the columnar elements. Now, due to the increased dicing required as one tries to decrease the cross-section area of the columnar sections, the time to fabricate a low cross-section area high-frequency probe increases as the cross-section of the columnar elements decreases. Also, the production yield of the dice-and-fill method for manufacturing high frequency probes is likely lower than that when the dice-and-fill method is used to manufacture conventional frequency probes, due the increased likelihood of breakage of the (thinner) piezoelectric ceramic wafer from which the probes are fashioned. Moreover, the dice-and-fill method is not amenable to be used for fabricating probes having aperiodic geometries. Such aperiodic probe geometries may enable enhanced cancellation of lateral vibration modes, which in turn, may potentially deliver a performance that is enhanced when compared to the performance of probes with a uniform geometry. Again, the dice-and-fill method cannot be used to create non-orthogonal column cross-sections such as, for instance, hexagons and circles. With a view to ameliorate the drawbacks of conventional dice-and-fill manufacturing methods as regards fabrication of piezoelectric elements having reduced size, as also to fabricate probes having aperiodic geometries, as also to have probes having aperiodic arrays of ultrasound transducer elements, several approaches have been explored in recent years. These include laser micromachining and direct write methods. Most of these approaches however, suffer from elaborate, and consequently expensive, fabrication procedures.

A method and a system that implements this method, to reliably and cost effectively fabricate piezoelectric probes including periodic or aperiodic geometries of piezoelectric elements with reduced dimensions along one or more physical directions, would, therefore, be highly desirable.

### BRIEF DESCRIPTION OF THE INVENTION

These and other advantages and features will be more readily understood from the following detailed description of preferred embodiments of the invention that is provided in connection with the accompanying drawings.

In accordance with one exemplary embodiment of the invention, a method for fabricating a sensing structure is provided. The method includes performing the steps of forming a functional layer, including an ultrasound transducer material and a photopolymer, and exposing a plurality of selected regions of the functional layer to a programmable light pattern to cure the selected regions of the functional layer to form polymerized ultrasound transducer material regions, repeatedly. The method further includes selectively removing unexposed regions of the functional layer to obtain a green component, and sintering the green component to obtain the sensing structure.

In accordance with another exemplary embodiment of the invention, a method for fabricating a sensing structure is provided. The method includes performing the steps of forming a functional layer including an ultrasound transducer material and a photopolymer, on a substrate by a wiping blade technique, and exposing a plurality of selected regions of the functional layer utilizing a digitally controlled programmable spatial light modulator module, wherein said exposing comprises systematically moving the digitally controlled spatial light modulator module to expose adjacent regions of the functional layer, thereby curing the selected regions of the functional layer to form polymerized ultrasound transducer material regions, repeatedly. The method further includes selectively removing unexposed regions of the functional layer to obtain a green component comprising an array of polymerized ultrasound transducer elements, and sintering the green component to obtain an array of ultrasound transducer elements having an aperiodic element spacing.

In accordance with yet another exemplary embodiment of the invention, a system for making at least one piezoelectric element is provided. The system includes a mechanical arrangement configured to form a functional layer on a substrate, wherein the functional layer comprises an ultrasound transducer material and a photopolymer, a spatial light modulator configured to expose at least one selected region of the functional layer to a programmable light pattern, thereby curing the said at least one selected region to form at least one polymerized ultrasound transducer region, and a heating assembly configured to sinter the at least one polymerized ultrasound transducer region to obtain at least one ultrasound transducer element.

In accordance with yet another exemplary embodiment of the invention, a system for making an array of ultrasound transducer elements is provided. The system includes, a mechanical arrangement configured to form a functional layer on a substrate, wherein the functional layer comprises an ultrasound transducer material and a photopolymer, a spatial light modulator configured to systematically expose adjacent regions of a plurality of selected regions of the functional layer to a digitally controlled programmable light pattern, thereby curing the plurality of selected regions to form a plurality of polymerized functional regions, and a heating assembly configured to sinter the polymerized ultrasound transducer regions to obtain an array of ultrasound transducer elements having an aperiodic element spacing.

### DESCRIPTION OF THE DRAWINGS

FIG. 1 is flow chart of a method for fabricating an array of ultrasound transducer elements according to an embodiment of the invention.

FIG. 2 schematically illustrates a wiping blade apparatus developed according to an embodiment of the invention.

FIG. 3 schematically illustrates a wiping blade apparatus developed according to an embodiment of the invention.

FIG. 4 schematically illustrates a spatial light modulator developed according to an embodiment of the invention.

FIG. 5 schematically illustrates a spatial light modulator developed according to an embodiment of the invention.

FIG. 6 is a schematic view of an array of ultrasound transducer elements, according to an embodiment of the invention.

FIG. 7 is a schematic view of an array of ultrasound transducer elements, according to an embodiment of the invention.

FIG. 8 is a schematic view of a part of an ultrasound transducer probe, according to an embodiment of the invention.

### DETAILED DESCRIPTION OF THE INVENTION

In the following description, like reference characters designate like or corresponding parts throughout the several views shown in the figures. It is also understood that terms such as “top,” “bottom,” “outward,” “inward,” “first,” “second,” and the like are words of convenience, and are not to be construed as limiting terms. Furthermore, whenever a particular aspect of the invention is said to comprise or consist of at least one of a number of elements of a group and combinations thereof, it is understood that the aspect may comprise or consist of any of the elements of the group, either individually or in combination with any of the other elements of that group.

Referring to the drawings in general, it will be understood that the illustrations are for the purpose of describing particular embodiments of the invention and are not intended to limit the invention thereto.

As used herein, the term “green,” when used in the context of a discussion of one or more components comprising a probe may mean a roughly held together object which may be produced as a result of intermediate processing steps leading to the formation of the final probe.

As used herein, the term “adjacent,” when used in the context of a discussion of different components comprising the probe refers to “immediately next to” or it refers to the situation wherein other components are present between the components under discussion.

In all embodiments and all situations described herein, where any component of the probe may be composed of more than one material, the more than one material together may be present in forms, including but not limited to, mixture, solid solution, and combinations thereof.

As used herein, the term “aperiodic,” when used in the context of a discussion of one or more components of the probe, may refer to the situation wherein the physical geometry and/or size of the one or more component is independently user-defined. In addition, the term may also refer to, and include the situation wherein the arrangement of the more than one component of the probe is also user-defined, and may be, for instance, non-uniform and/or uniform.

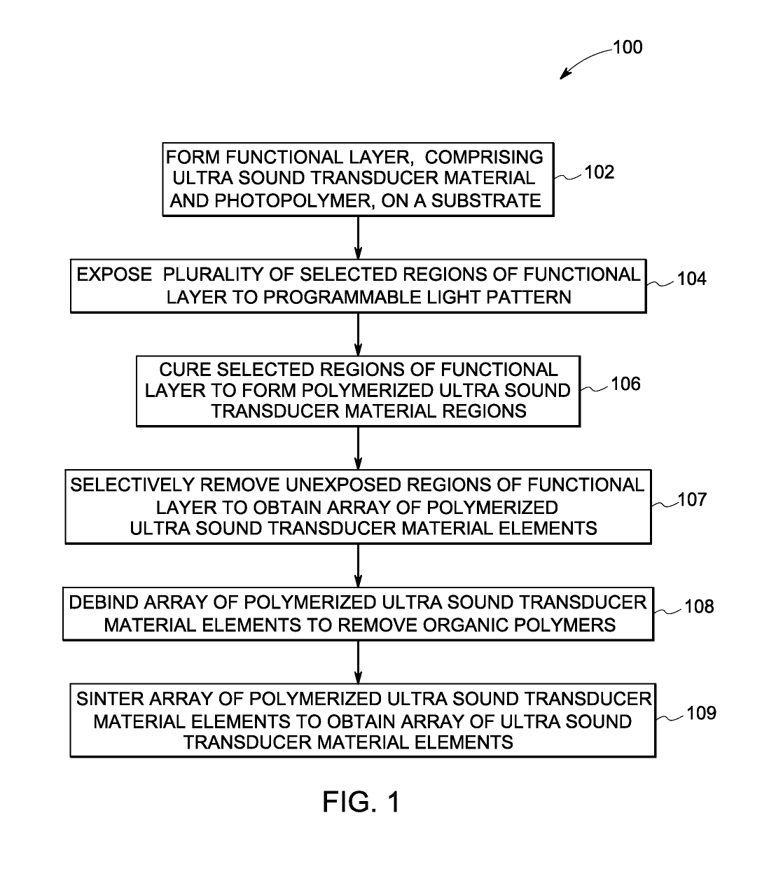

One embodiment of the invention is directed to a method for fabricating an array of ultrasound transducer elements. FIG. 1 shows a flow chart of a method 100 for fabricating an array of ultrasound transducer elements. The method 100 includes the step 102 of forming a functional layer on a substrate. The functional layer includes an ultrasound transducer material, and a photopolymer (a polymer that polymerizes photochemically). The ultrasound transducer material may include one or more conductive material and/or one or more piezoelectric material. The method 100 further includes at step 104, exposing a plurality of selected regions of the functional layer to a programmable light pattern. Next, the method 100 includes at step 106 curing the selected regions of the functional layer to form polymerized ultrasound transducer regions. Then, the method 100 includes selectively removing unexposed regions of the functional layer to obtain an array of polymerized ultrasound transducer elements at step 107. Next, the method 100 includes at step 108, debinding an array of polymerized ultrasound transducer elements to remove organic polymers. Finally, the method 100 includes sintering the array of polymerized ultrasound transducer elements to obtain an array of ultrasound transducer elements at Step 109.

In step 102 a functional layer of a desired thickness is formed. Any suitable method for forming thin uniform functional layers may be used for forming the functional layer. This functional layer may include a material that is conductive and/or piezoelectric. In one embodiment, a slurry based method is used for preparing the functional layer. Some examples of suitable functional layer forming techniques include, but are not limited to, a wiping blade technique, a knife blade technique, a doctor blade technique, and screen printing. In a slurry based process, typically a powder of desired, ultrasound transducer material having a suitable particle size is mixed with a photopolymer. It is likely that, for better processing of the slurry, it may be advantageous to use ultrasound transducer material particles with extremely narrow particle size distribution and uniform spherical morphology. Particle size and shape likely have influence on the Theological properties of the slurry. Particle size and morphology likely also influence the packing density in the functional layer. The amount of ultrasound transducer material powder in the slurry is generally adjusted to have the appropriate rheological character advantageous in the given situation. Further additive agents may be mixed into the slurry, such as a dispersing agent for improving dispersibility and to inhibit rapid settling. According to certain embodiments, the method may thus include the additional optional steps of de-agglomeration and de-airing of the slurry for better results. A variety of substrates may be used. The materials from which the substrates may be composed of include, but are not limited to, plastic, glass, mica, metals, ceramics, or combinations thereof.

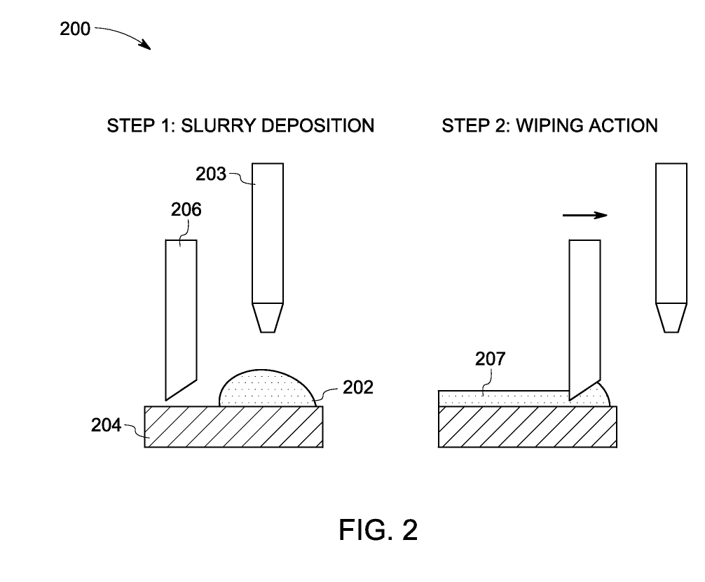

In one embodiment, the functional layer is formed by a wiping blade technique. FIG. 2 schematically shows a possible arrangement of a wiping blade technique developed according to one embodiment of the invention. In the wiping blade technique, first a slurry comprising, an ultrasound transducer material, and a photopolymer is prepared. With the help of a dispenser 203, a bead of the slurry 202, comprising the ultrasound transducer material and a suitable photopolymer, is formed on a substrate 204. The size of the bead and the rate of bead formation may be controlled as per requirements. A blade 206 is used to wipe the slurry bead 202 to make a functional layer 207 having a desired thickness. The wiping blade technique potentially provides advantages in terms of feasibility of handling highly viscous slurries, and capability of forming very thin and uniform functional layers. Thin functional layers (5-10 microns) composed of a high volume percentage (40-45%) of 1-2 micron sized polycrystalline particles, of say, a piezoelectric material, and photopolymer may be formed by this method 100.

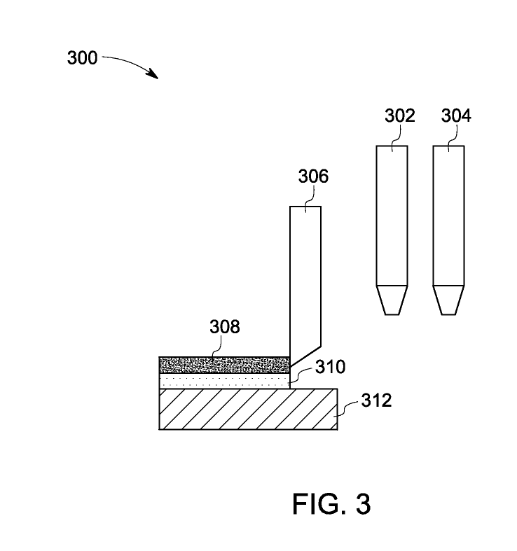

Additionally, method 100 enables independent co-deposition of more than one, same or different, slurries of, same or different materials, by placing different slurries in different dispensers. FIG. 3 shows co-deposition of the case of two materials 308 and 310, onto the substrate 312, by utilizing two dispensers 302 and 304, to contain the two slurries respectively. A blade 306 is used to wipe the slurry beads to make functional layers 308 and 310 having desired thicknesses. Multiple blades may be used when depositing more than one materials to create layers without contamination. The extension of this methodology to more than two slurries, and/or deposition of more than two layers is straightforward. Co-deposition may be used to fabricate multilayered structures, for example, damping, conducting, and piezoelectric ceramic functional layers may be deposited, in independent geometries. The co-deposition ability may also be useful in the co-deposition of graded acoustically matched layers, and/or also of electrodes. This co-deposition of graded acoustically matched layers and/or electrodes may potentially enhance penetration and resolution abilities of the ultimately fabricated probes. Such co-deposition may mitigate the need for a bonding layer that may typically be needed to bond different layers. This may potentially improve acoustic performance at high frequencies. Probes including such multilayered structures may be amenable to work at low voltages, which in turn, may allow for their use in applications where portability is desirable. An example of one such portable application may be for a handheld ultrasound device for in-situ measurements on installed infrastructure.

In one embodiment, the functional layer may include at least one ultrasound transducer material and at least one photopolymer. The ultrasound transducer material may be either piezoelectric or conductive or acoustic. In one embodiment, the functional layer may include a piezoelectric material and a photopolymer. Any suitable piezoelectric material may be used in the functional layer. Some examples of suitable ferroelectric piezoelectric materials include, but are not limited to, lead zirconate titanate, lead metaniobate, lithium niobate, bismuth titanate, lead titanate, or combinations thereof. In a specific embodiment, the piezoelectric material includes lead zirconate titanate (PZT). PZT is a standard piezoceramic that is widely used in commercial ultrasound transducers. Some examples of suitable “relaxor ferroelectric” piezoelectric materials include, but are not limited to, lead magnesium niobate, lead zinc niobate, lead nickel niobate, bismuth scandium oxide, and/or solid solutions thereof. In another embodiment, the functional layer may include a conductive material and a photopolymer. Any suitable conductive material may be used in the functional layer. Some examples of suitable conductive materials include, but are not limited to, platinum, palladium, platinum-palladium alloys, or combinations thereof. Typically, any photopolymer compatible with the one or more ultrasound transducer materials used to form the functional layer, and which polymerizes on exposure to a light of given a given wavelength distribution may be used in the process of manufacture 100. The wavelength distribution of the light used, depending on the situation, may be monochromatic or polychromatic. In certain embodiments, additional photo initiators may be used in order to initiate the polymerization process. A number of photopolymers are known. The factors to consider when choosing the appropriate photo initiators and photopolymer would be known to one skilled in the art.

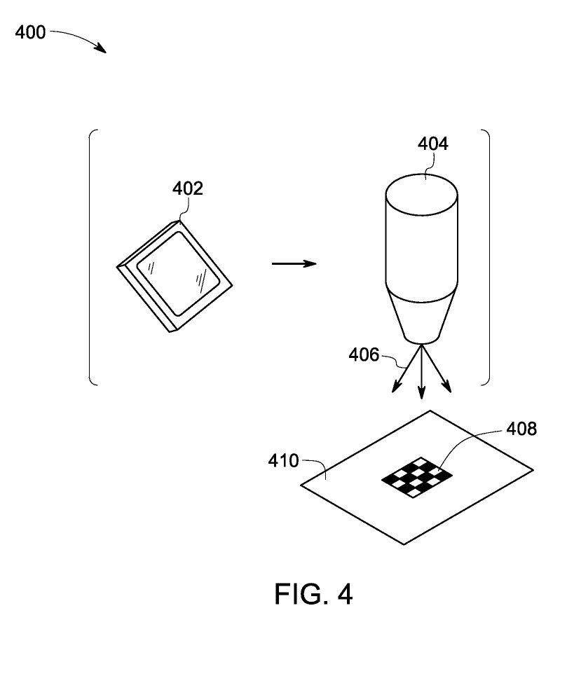

In step 104 (FIG. 1) a plurality of selected regions of the functional layer is exposed to light of suitable intensity and wavelength distribution that is capable of initiating a polymerization process. This can be achieved by utilizing a system 400 that includes a computer 402, capable of providing digital control signals to control the spatial light modulator module 404 (shown in FIG. 4) modulating light intensity and/or direction to generate a predetermined light pattern 408 on the functional layer 410. In one embodiment, the programmable light pattern 406 may be digitally controlled. Embodiments of the invention include a system and a method that uses computer generated electronic control signals and a spatial light modulator, without any photomask, to project a predetermined light pattern on to the plurality of selected regions of the functional layer to expose and cure the selected regions of the functional layer (schematically shown in FIG. 4). Each functional layer is exposed to a digitally masked light beam of suitable intensity and wavelength distribution, and the imaging of individual features is dynamically achieved by the computer control. Typically, a digital pattern representing the cross-section of the structure to be fabricated is projected onto the functional layer. This selectively cures the photopolymer present within the selected region of the functional layer, to yield polymerized regions within the functional layer. A conventional optical lithographic process typically requires several photolithographic steps and associated unique photo masks. At each stage of the process, the photo masks need to be changed. This leads to addition of substantial lead-time and complexity to the process. A process that does not involve a photomask may therefore be more efficient.

FIG. 4 shows a system including a spatial light modulator 404 configured to expose and cure a plurality of selected regions of the functional layer 410 to a programmable light pattern 406 to form “green” polymerized ultrasound transducer regions 408, in accordance with one embodiment of the invention. A digital control module 402 may be configured to control the spatial light modulator 404, which then gives a digitally controlled light pattern 406. The requirement for a photomask is thus alleviated. The spatial light modulator 404 projects a programmable light pattern 406 onto the functional layer 410. This process wherein a light pattern 406 is projected onto the functional layer 410 via programmable digital control therefore serves functionally as a “digital mask”. The spatial modulator is modified to obtain collimated beams capable of fabricating ultrasound transducer elements having a cross-section of down to about 5 microns. Embodiments of the invention may be configured to expose and cure a plurality of selected regions of the functional layer 410, wherein the selected regions have an aperiodic spacing and/or independently different physical dimensions, and/or independently different shapes.

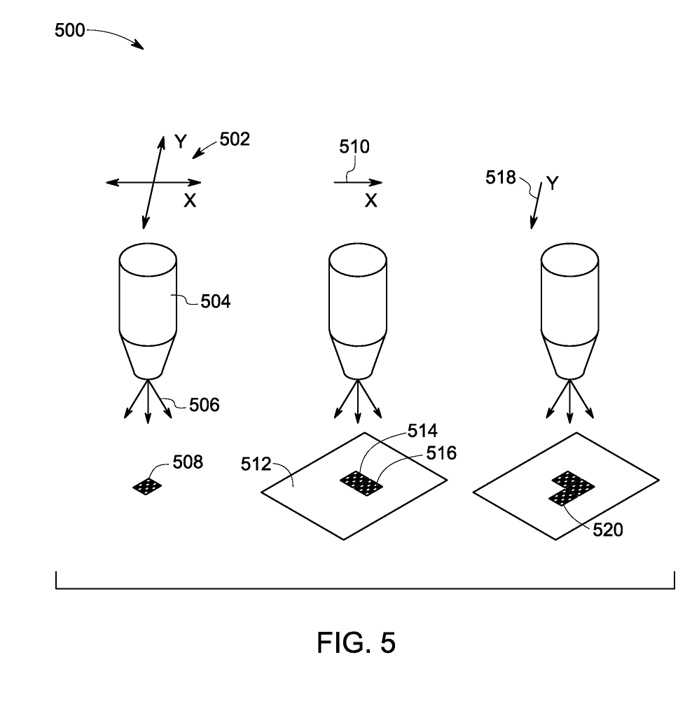

FIG. 5 illustrates a scheme 500 for systematically moving the spatial light module to expose adjacent regions of the functional layer, using a “step-and-scan” technique, according to one embodiment of the invention. In this technique, the spatial light modulator module 504 is configured to be movable in a horizontal plane along the x- and y-directions 502 to emit the digitally programmable light beam 506 according a desired exposure pattern 508. The spatial light modulator module 504 may also be configured to be movable along the z-direction (not shown). For instance, the spatial light modulator module 504 may be translated along the x-direction 510 to produce the exposure patterns 514 and 516 on the functional layer 512. In similar vein, the spatial light modulator module 504 may be translated along the y-direction 518 to produce another exposure pattern 520 on the functional layer 512. The use of this step-and-scan technique enables the fabrication of larger parts using the small area, high resolution, digital masks. A promising approach herein is the development of Projection MicroStereoLithograhy (PMSL) to make ceramic parts. In PMSL, the input material is a slurry composed of an ultrasound transducer material and a photopolymer. A digital mask is generated using a DLP™ (Digital Light Processing, registered trademark of Texas Instruments, Inc., Dallas, Tex., USA) Digital Micro-Processing (DMD) device or an LCD (Liquid Crystal Display) device. This mask is projected on to the slurry to selectively cure it. A plurality of functional layers are then deposited and cured, one on top of the other, to get the required shape and thickness. In its present form, the maximum size of the parts that can be created by PMSL are limited by the resolution and size of the digital mask generator. The maximum part size created with PMSL, as known in the art at present, is limited about to 1.5 inches by 1.5 inches at a resolution of about 15 microns. In this invention, we outline a method to scale-up PMSL to make bigger parts while retaining the high resolution. This invention enables the use of PMSL in the fabrication of ultrasound transducer probes such as piezoelectric ultrasonic probes. As has been alluded to, the small size of the available digital mask generators has thus far limited the maximum size of the part that can be fabricated using PMSL. The use of this step-and-scan approach enables the fabrication of larger parts using the small area, high resolution digital masks. Embodiments of the invention may greatly enhance the process capability by enabling processing of a wide area of the surface in a single scanning step. This can be achieved by systematically moving either the substrate or the spatial light modulator module relative to the other, as will be described in detail below.

Any suitable mechanism of generating and dynamically changing an intended image pattern may be used for the purpose. One such mechanism includes a spatial light modulator. Such modulators may be electronically controlled by a computer to generate predetermined image patterns. Such digital control facilitates generation of very fine feature sizes and also fast dynamically controllable control signals. Such modulators are available in a variety of types. Some examples of suitable spatial light modulator module includes, but are not limited to, a Grating Light Valve (GLV™, available from Silicon Light Machines, Sunnyvale, Calif., USA), a DLP™ Digital Micro-mirror Device (DLP™, manufactured by Texas Instruments, Inc., Dallas, Tex., USA), and Liquid Crystal Display (LCD). Such spatial light modulators operate as both directional and intensity modulators of the light. In certain embodiments, commercially available spatial light modulators are augmented with additional functionality as desired for specific applications. For example, depending on the photopolymers used, the light sources may be replaced or additional bandpass filters may be included to generate light of a specific wavelength distribution. In other embodiments, a lens system may be used along with the modulator to generate collimated beams that facilitate generation of images of desired magnification. For example, convergent beams may be useful to generate images of fine features. The considerations involved in making the choice of a spatial light modulator that is compatible with the given wavelength distribution and intensity of light, and with the synthesis chemistries at play during the fabrication of the probe, would be known to one skilled in the art.

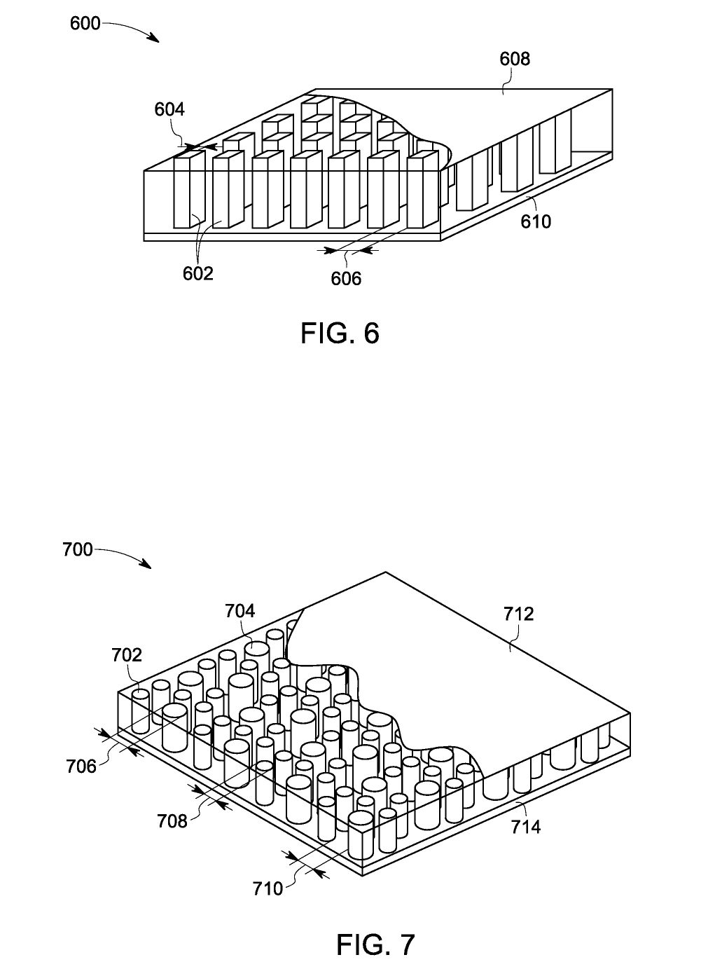

FIG. 6 schematically represents an array 600 of ultrasound transducer elements 602, fabricated according to one embodiment of the invention. When used as an ultrasound transducer probe 608, for efficient working of the ultrasound transducer probe, the ultrasound transducer elements 602 desirably have a sufficiently small cross-section 606 compared to an one or more ultrasonic wavelengths likely to be present during operation of the probe. The method 100 (FIG. 1) is suitable for fabricating fine ultrasound transducer elements and closely spaced ultrasound transducer elements.

The method 100 is suitable for fabricating aperiodically spaced polymerized ultrasound transducer elements. FIG. 7 schematically represents an aperiodic array 700 of ultrasound transducer elements 702 and 704, according to one embodiment of the invention. When used as an ultrasound transducer probe 712, the ultrasound transducer elements, as represented by, say, 702 and 704 can have, independently different physical dimensions 708 and 706 respectively. In one embodiment, the aperiodically spaced polymerized ultrasound transducer regions have a minimum spacing between neighboring regions 710 of about 25 microns. In another embodiment, the aperiodically spaced polymerized ultrasound transducer regions have a minimum spacing between neighboring ultrasound transducer regions 504 of about 50 microns. It is known in the art that such aperiodically spaced ultrasound transducer elements, when used as an ultrasound transducer probe, provide advantages of better resolution by eliminating lateral modes of one or more ultrasound wavelengths traveling in the array.

In step 107 (FIG. 1), unexposed regions of the functional layer are selectively removed. Any suitable method may be used for removing unexposed regions. Some examples of processes suitable to remove unexposed “binder” material include, but are not limited to, dissolving in a suitable solvent, chemical etching, or combinations thereof. In one embodiment, unexposed regions are selectively removed by washing the exposed functional layer with isopropyl alcohol in an ultrasonic bath for a few, say 5, minutes. In step 18, the polymerized ultrasound transducer elements are debinded by heating the polymerized ultrasound transducer elements in oxygen to remove the organic polymers. In one embodiment the debinding temperature is in a range from about 400° C. to about 800° C. The debinding temperature may depend, amongst other factors, on the polymer and the ultrasound transducer material.

In step 109, the array of polymerized ultrasound transducer elements is sintered by heating the array of polymerized ultrasound transducer elements to a suitable sintering temperature. The sintering may be useful to densify the “green” ultrasound transducer elements. In one embodiment, the sintering temperature is in a range from about 1000° C. to about 1300° C. The choice of sintering temperature depends, amongst other factors, on the ultrasound transducer material. The considerations involved in making the choice of a sintering temperature and sintering duration, as dependent on the materials system used, would be known to one skilled in the art. Three-dimensional ultrasound transducer parts, made of, for instance, ceramic materials, may be created by stacking multiple layers of the cured ultrasound transducer-photopolymer slurry layers. De-binding and sintering, as explained above, may used to create densely packed ultrasound transducer probes.

In one embodiment, the method 100 includes the steps of: forming repeatedly, as many times as desired, a functional layer, including an ultrasound transducer material, and a photopolymer, on a substrate by a wiping blade technique; exposing repeatedly, as many times as desired, a plurality of selected regions of the functional layer utilizing a digitally controlled programmable spatial light modulator module to expose adjacent regions of the functional layer, thereby curing the selected regions of the functional layer to form polymerized ultrasound transducer material regions; selectively removing unexposed regions of the functional layer to obtain an array of “green” polymerized ultrasound transducer elements; and sintering the array of green polymerized ultrasound transducer elements to obtain an array of ultrasound transducer elements having an aperiodic arrangement of the ultrasound transducer elements. The light pattern is systematically moved to expose adjacent regions of the functional layer, in order to expose a large area of the substrate.

The methods described with reference to several embodiments of the invention are substantially different from conventional methods known in the art. There have been recent reports of methods alternate to conventionally used dice-and-fill methods, to fabricate ultrasound transducer elements. Many of these methods involve photo masks to define the feature sizes of the device to be fabricated. In contrast, in the methods described herein in the context of some embodiments of the invention, the process is free of photo masks and the associated complexities and disadvantages as described earlier. Further, most of these conventional methods are incapable of fabricating aperiodically spaced ultrasound transducer elements of very fine sizes. Embodiments of the invention demonstrate fabrication of aperiodically spaced ultrasound transducer elements having dimensions as small as 15 microns. Further, one embodiment of the invention is a method that may be used to fabricate single element probes with three-dimensional geometries having improved acoustic properties. Co-fabrication of the damping layer with the functional layers improves acoustic properties in high frequency probes. Direct fabrication of thin ceramic elements with electrodes for use in high frequency probes is possible via this method. The graded matching layers may be fabricated such that the impedance of the probe closely matches the impedance of, say human body tissue, allowing for enhanced imaging.

In another embodiment of the invention, a system for fabricating an array of ultrasound transducer elements is provided. The system comprises a mechanical arrangement configured to form a functional layer on a substrate, wherein the functional layer comprises a piezoelectric material or a conductive material, or combinations thereof, and a photopolymer. The system also includes a spatial light modulator configured to expose and cure a plurality of selected regions of the functional layer to a programmable light pattern to form polymerized ultrasound transducer regions. The system also includes a heating assembly configured to sinter the polymerized ultrasound transducer regions to obtain an array of ultrasound transducer elements.

Any suitable mechanical arrangement, which facilitates the formation of thin layers composed of at least one piezoelectric material, and/or of at least one conductive material, may be used. Some examples of such mechanical arrangements include, but are not limited to, a wiping blade apparatus, a doctor blade apparatus, a knife blade apparatus, and screen printing. In one embodiment, the mechanical arrangement includes a wiping blade apparatus 200, as shown in FIG. 2. In certain embodiments, the wiping blade apparatus is modified by adopting several dispensers to co-deposit slurries of one or more materials.

Embodiments of the invention also include a system for systematically moving the projected light pattern to expose adjacent regions of the functional layer, as shown in FIG. 5. This may be achieved by facilitating systematic relative movement of the modulator or the substrate along x, y, or z directions. For example, a servo-motor driven translation stage may be used. The modulator or the substrate may be moved systematically until a desired area of the substrate is covered. A three-dimensionally shaped aperiodic array transducer with elements having independently different geometrical shapes and independently different physical dimensions may be created by varying the geometry of the digital mask from layer to layer. Conventionally used dice-and-fill methods may be limited in their ability to create three-dimensional parts. Moreover, the boundaries of the ultrasound transducer elements are limited to be straight lines using the dice-and-fill method.

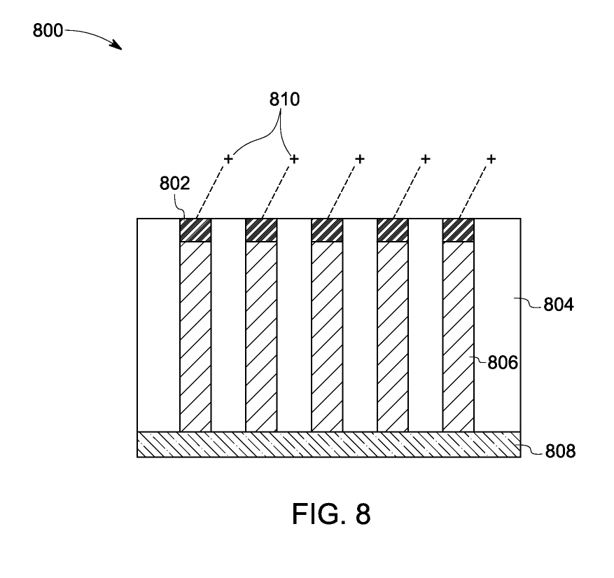

FIG. 8 shows in cross-sectional schematic view an array of transducer elements in accordance with an embodiment of the invention. The transducer comprises an array of piezoelectric ceramic columns 806 with electrodes plated on “top” 802, and “bottom” side 808, to provide electrical contact 810. The piezoelectric material converts electrical energy into ultrasonic energy. The space between the columns is filled with an epoxy 804. The epoxy lowers the acoustic impedance of the transducer, creating more efficient acoustic coupling between the transducer and the part being inspected, especially nonmetallic test materials such as composites and polymers

In one embodiment, the system includes an etching system configured to selectively removing unexposed binder regions of the functional layer to obtain an array of polymerized ultrasound transducer elements. The etching system may be composed of a solvent to remove the uncured slurry in an ultrasonic bath.

In one embodiment, the system also comprises a heating assembly to sinter the array of green polymerized ultrasound transducer elements. Typically, the heating assembly is configured to sinter the array of green polymerized ultrasound transducer elements in a temperature within a range from about 1000° C. to about 1300° C. The actual operating temperature depends on the ultrasound transducer material to be processed.

In an exemplary embodiment of the system configured to make at least one ultrasound transducer element, the system includes: a mechanical arrangement configured to form a functional layer including an ultrasound transducer material and a photopolymer, on a substrate; a spatial light modulator configured to systematically move to expose at least one selected region of the of the functional layer to a programmable light pattern, thereby curing the said at least one selected region to form at least one polymerized ultrasound transducer region; and a heating assembly configured to sinter the at least one polymerized ultrasound transducer regions to obtain at least one ultrasound transducer element.

In one embodiment, the system may be suitable for fabricating an array of ultrasound transducer elements having high resolution and operable to high frequencies. The system may be utilized to fabricate three-dimensional structures as discussed in detail in the method embodiments.

The system described herein facilitates manufacturing of compact, and high-resolution array of ultrasound transducer elements. This approach potentially may result in a reduction in the cost of manufacture of these probes. Utilization of such array of ultrasound transducer elements in ultrasonic probes is expected to enhance the frequency of operation as well.

The following example describes the preparation method for making an array of PZT elements. This example is merely illustrative, and embodiments of the invention are not limited to this example.

### EXAMPLE

A PZT slurry may be prepared by mixing 1,6 Hexanediol Diacrylate (HDDA), PZT 5H powder (TRS Technologies, State College, Pa., USA), Irgacure 819 (available from Ciba Specialty Chemicals, New York, USA) and Triton X100 (available from Sigma-Aldrich, St. Louis, Mo., USA). This slurry may have between 40-45% PZT 5H powder by volume. The PZT 5H powder used has a mean particle size of 1-5 microns. The PZT 5H powder may be dispersed and suspended in the photopolymer (HDDA) by Triton X100. The concentration of Triton X100 in the slurry may be between 5-10% by weight of the PZT 5H powder. Irgacure 819 is used as a photoinitiator to initiate free radical polymerization in HDDA when exposed to light. The concentration of Irgacure 819 may be between 5-10% by weight of HDDA. Next, layers of this slurry having thickness in the range about 10 microns to about 40 microns may be deposited on a substrate using the doctor blade technique. These layers may be exposed to a digital mask with dimensions of about 7 mm by 10 mm for about 5 seconds. The mask may represent the cross-section of the columnar structure. The columns may be between 20 microns and 100 microns in diameter with a mean inter-column distance of about 100 microns. This mask may be moved to 4 different locations to create a part having physical dimensions of about 14 mm times 20 mm. Next, 20 layers may be deposited one on top of the other. The part may then be washed in isopropyl alcohol in an ultrasonic bath for about 5 minutes. This may be followed by thermal debinding in oxygen between about 400° C. to about 700° C. Finally, the parts may be sintered in a lead environment in the temperature range of about 1100° C. to about 1250° C. for about 2-3 hours.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed as new and desired to be protected by Letters Patent of the United States is:

1. A method for fabricating a sensing structure, the method comprising the steps of:
(a) forming a functional layer, comprising an ultrasound transducer material and a photopolymer;
(b) exposing a plurality of selected regions of the functional layer to a programmable light pattern to cure the selected regions of the functional layer to form polymerized ultrasound transducer material regions;
(c) repeating steps (a) and (b); (d) selectively removing unexposed regions of the functional layer to obtain a green component; and
(e) sintering the green component to obtain the sensing structure.

2. The method of claim 1, wherein the ultrasound transducer material refers to piezoelectric material and conductive material.

3. The method of claim 2, wherein said ultrasound transducer material comprises a ferroelectric piezoelectric material comprising lead zirconate titanate, lead metaniobate, lithium niobate, bismuth titanate, lead titanate, lead magnesium niobate, lead zinc niobate, lead nickel niobate, bismuth scandium oxide, or combinations thereof.

4. The method of claim 2, wherein ultrasound tranducer material comprises a conductive material comprising platinum, palladium, platinum-palladium alloys, or combinations thereof.

5. The method of claim 1, wherein the functional layer comprises one or more conducting layers and one or more piezoelectric layers that can be co-deposited and co-sintered.

6. The method of claim 1, wherein the functional layer comprises one or more matching piezoelectric layers that can be co-deposited.

7. The method of claim 1, wherein said forming a functional layer comprises a method comprising, a wiping blade technique, a knife blade technique, a doctor blade technique, screen printing, extrusion coating, slot coating, waterfall coating, or combinations thereof.

8. The method of claim 1, wherein said exposing a plurality of selected ultrasound transducer material regions of the functional layer comprises utilizing a spatial light modulator module modulating light intensity or direction to generate a predetermined light pattern.

9. The method of claim 8, wherein the spatial light modulator module comprises, a DLP, a LCD, a collimated light beam passing through a fixed physical mask, or combinations thereof.

10. The method of claim 8, wherein the programmable light pattern comprises a digitally controlled light pattern.

11. The method of claim 1, wherein said exposing a plurality of selected ultrasound transducer material regions comprises systematically moving the spatial light modulator module to expose adjacent regions of the functional layer.

12. The method of claim 1, wherein said exposing a plurality of selected regions comprises exposing regions which are aperiodically spaced to obtain an aperiodic arrangement of ultrasound transducer material polymerized regions.

13. The method of claim 1, wherein said exposing a plurality of selected regions comprises exposing regions which are periodically spaced to obtain a periodic arrangement of ultrasound transducer material polymerized regions.

14. The method of claim 1, wherein said exposing a plurality of selected regions comprises exposing and polymerizing regions which independently have different user-defined shapes.

15. The method of claim 1, wherein said selectively removing unexposed regions of the functional layer comprises removing by washing the polymerized part, in a solvent in an ultrasonic bath.

16. The method of claim 1, wherein said debinding and sintering the array of polymerized elements comprises heating the array of polymerized elements.

17. A method for fabricating a sensing structure, the method comprising the steps of:
(a) forming a functional layer comprising an ultrasound transducer material and a photopolymer, on a substrate by a wiping blade technique;
(b) exposing a plurality of selected regions of the functional layer utilizing a digitally controlled programmable spatial light modulator module, wherein said exposing comprises systematically moving the digitally controlled spatial light modulator module to expose adjacent regions of the functional layer, thereby curing the selected regions of the functional layer to form polymerized ultrasound transducer material regions;
(c) repeating steps (a) and (b);
(d) selectively removing unexposed regions of the functional layer to obtain a green component comprising an array of polymerized ultrasound transducer elements; and
(e) sintering the green component to obtain an array of ultrasound transducer elements having an aperiodic element spacing.

18. The method of claim 17, wherein the functional layer comprises a piezoelectric material.

19. A system for making at least one piezoelectric element, the system comprising:
a mechanical arrangement configured to form a functional layer on a substrate, wherein the functional layer comprises an ultrasound transducer material and a photopolymer;
a spatial light modulator configured to expose at least one selected region of the functional layer to a programmable light pattern, thereby curing the said at least one selected region to form at least one polymerized ultrasound transducer region; and
a heating assembly configured to sinter the at least one polymerized ultrasound transducer region to obtain at least one ultrasound transducer element.

20. The system of claim 19, wherein the functional layer comprises a piezoelectric material.

21. The system of claim 19, wherein the mechanical arrangement comprises a wiping blade set up, a doctor blade set up, a knife blade set-up, or combinations thereof.

22. The system of claim 19, wherein the dispensing arrangement comprises, an extrusion coater, a slot coater, a waterfall coater, or combinations thereof.

23. The system of claim 19, wherein the spatial light modulator is configured to give a digitally controlled light pattern.

24. The system of claim 19, wherein the spatial light modulator is configured to expose and cure a plurality of selected regions of the functional layer.

25. The system of claim 19, wherein the spatial light modulator comprises, a DLP, a LCD, a collimated light passing through a physical mask, or combinations thereof.

26. The system of claim 19, wherein the spatial light modulator is configured to systematically move a spatial light modulator module to expose adjacent regions of the functional layer.

27. The system of claim 19, comprising an etching system configured to selectively remove unexposed regions of the functional layer to obtain an array of polymerized ultrasound transducer elements.

28. The system of claim 19, wherein the heating assembly is configured to debind and sinter the array of polymerized ultrasound transducer elements.

29. A system for making an array of ultrasound transducer elements, the system comprising:
a mechanical arrangement configured to form a functional layer on a substrate, wherein the functional layer comprises an ultrasound transducer material and a photopolymer;
a spatial light modulator configured to systematically expose adjacent regions of a plurality of selected regions of the functional layer to a digitally controlled programmable light pattern, thereby curing the plurality of selected regions to form a plurality of polymerized functional regions; and
a heating assembly configured to sinter the polymerized ultrasound transducer regions to obtain an array of ultrasound transducer elements having an aperiodic element spacing.

30. The system of claim 29, wherein the functional layer comprises a piezoelectric material.
